(19) United States
(12) Patent Application Publication
(10) Pub. No.: US 2026/0169150 A1
(43) Pub. Date: Jun. 18, 2026

(54) TRACKING SYSTEM EXPLOITING OVER-THE-HORIZON BURST COMMUNICATIONS VIA HYPERSONIC VEHICLE IONIZATION TRAILS

(71) Applicant: BAE Systems Information and Electronic Systems Integration Inc., Nashua, NH (US)

(72) Inventor: Michael J. DeWeert, Kaneohe, HI (US)

(73) Assignee: BAE Systems Information and Electronic Systems Integration Inc., Nashua, NH (US)

(21) Appl. No.: 18/978,475

(22) Filed: Dec. 12, 2024

(51) Int. Cl. G01S 13/72

(52) U.S. Cl. CPC G01S 13/72

(57) ABSTRACT

A system and method may include a manmade hypersonic object that generates a plasma stream in the atmosphere in response to the manmade hypersonic object moving at a hypersonic speed. There may be a first over-the-horizon (OTH) communication system at a first location. There may be a second OTH communication system at a second location that is over the horizon relative to the first OTH communication system at the first location. The first OTH communication system may be configured to transmit a signal to the plasma stream that is then reflected to the second OTH communication system. The system and method may also be utilized to track the object. The first OTH communication system may be self-localized with other communications located on the same side of the horizon.

### TECHNICAL FIELD

The present disclosure relates to over-the-horizon communications.

### BACKGROUND ART

Line-of-sight (LOS) communications rely on a direct path between the transmitting and receiving antennas, without any significant obstructions or obstacles in between. This means that the antennas must have a clear line of sight to each other for effective communication. However, ordinary LOS communications cannot operate over the horizon due to a variety of factors. One factor is that the Earth's surface is curved, and as a result, the horizon blocks the direct line of sight between two points that are far apart. As the distance between the transmitting and receiving antennas increases, the curvature of the Earth becomes more pronounced, leading to an increasing physical obstruction. Even if the curvature of the Earth is not a significant obstacle, signals, such as radio frequency (RF) signals, still experience attenuation as they propagate through the atmosphere. As the signal travels a longer distance, it weakens due to factors such as free space loss, atmospheric absorption, and scattering. Eventually, the signal strength becomes too weak to be reliably detected at the receiver. Another factor is that diffraction and scattering of RF signals occur when they encounter obstacles, such as hills, buildings, or other terrain features. These obstacles can cause the signals to bend, scatter, or reflect in different directions. As a result, the signals may not reach the intended receiver, especially if there are multiple obstacles or if the terrain is complex.

To overcome the limitations of LOS RF communications over the horizon, other techniques and technologies are employed, such as satellite communications, High-Frequency (HF) Radio, and Over-the-Horizon (OTH) Radar.

OTH radar systems use advanced signal processing techniques to detect and track objects beyond the line of sight. These systems exploit the scattering and reflection of radio waves by the ionosphere or other atmospheric layers to extend their range. While this OTH technology has its advantages, it also presents several problems and difficulties. For example, there are problems with attenuation, latency, and interference.

With respect to propagation and signal attenuation, RF signals weaken and experience attenuation as they travel over long distances. Factors such as atmospheric conditions, interference, and obstacles in the propagation path can further degrade the signal quality. This attenuation can result in reduced signal strength, increased noise, and potential data loss.

With respect to delay and latency, OTH RF communications involve transmitting signals over vast distances, which introduces significant propagation delays. The time taken for the signal to reach its destination and for a response to return can result in noticeable latency. This delay can be problematic in real-time applications, such as voice or video communication, where immediate feedback is necessary.

With respect to interference and noise, RF communications are susceptible to interference from various sources, including other RF devices, atmospheric disturbances, and electrical equipment. The signals can be distorted or disrupted, leading to reduced signal quality and increased error rates. Noise from natural or man-made sources can also degrade the signal-to-noise ratio and make it challenging to extract useful information.

Despite these challenges, OTH RF communications continue to be important for long-range communication needs. Ongoing advancements in technology, signal processing techniques, and network infrastructure aim to mitigate these difficulties and improve the reliability and performance of such systems.

High-Frequency (HF) radio refers to the use of radio waves within a specific frequency range, typically between 3 and 30 MHz, for long-range communication. One of the unique properties of HF radio waves is their ability to interact with the Earth's ionosphere, a layer of charged particles in the upper atmosphere. This interaction enables HF signals to refract or bounce off the ionosphere, allowing for long-distance or OTH communication beyond the line of sight.

When an HF radio signal encounters the ionosphere during OTH communications, it interacts with the ionized particles present in that layer of the atmosphere. The ionosphere consists of free electrons, positive ions, and neutral particles. Some of the ionized particles may be created by meteors entering the atmosphere.

When an HF radio signal encounters the ionosphere, the presence of free electrons and positive ions allows for interactions to take place. These interactions can cause the radio signal to be refracted or bent back towards the Earth's surface. These interactions may include: a. Absorption: Some of the energy from the HF signal can be absorbed by the ionized particles in the ionosphere, causing the signal to weaken; b. Reflection: The ionized particles can reflect a portion of the HF signal, bouncing it back towards the Earth. This reflection allows for long-range communication by redirecting the signal over the horizon; and c. Refraction: The ionized particles cause the HF signal to change direction by altering its speed. This refraction effect depends on the density and composition of the ionosphere, as well as the frequency of the radio signal. The refracted signal can be bent towards the Earth's surface, allowing communication beyond the line of sight.

The ionosphere is composed of distinct layers, each with its own characteristics and ionization levels. These layers include the D layer, E layer, F1 layer, and F2 layer. Each layer plays a role in the interaction of HF signals. The D layer is closest to the Earth's surface and is mainly active during the day. It absorbs HF signals, making it less useful for long-range communication. The E layer, located above the D layer, is active during both day and night. It reflects HF signals at certain frequencies, enabling medium-range communication. The F layer consists of two sub-layers, F1 and F2, located at higher altitudes. The F layer is most active during daylight hours and can refract and reflect HF signals, allowing for long-range communication.

Another specific communication that utilizes atmospheric ionization is meteor ionization burst communications, also known as meteor scatter communications or meteor burst communications, is a technique that takes advantage of ionized trails left by meteors entering Earth's atmosphere to facilitate radio communication over long distances. When a meteoroid (a small particle from space) enters Earth's atmosphere, it undergoes rapid heating due to atmospheric friction, causing it to vaporize. This vaporization process ionizes the surrounding air, creating an ionized trail or plasma trail along the meteor's path. When a radio wave encounters an ionized trail in the atmosphere, it can be reflected or scattered by the ionized particles within the trail. The radio wave interacts with the plasma's free electrons, causing changes in its path and propagation characteristics. The ionized trail acts as a temporary reflector for radio waves. The radio signal can be reflected off the ionized trail back towards Earth, allowing for over-the-horizon communication. Additionally, the signal can scatter in various directions due to irregularities in the plasma trail, resulting in multiple paths and increased coverage.

Meteor ionization burst communications typically involve short-duration communication bursts that occur when a meteoroid passes through the atmosphere, creating a temporary ionized trail. The bursts can last from a fraction of a second to a few seconds, depending on the meteor's size and speed. Meteor ionization burst communications are often characterized by their bursty nature and high Doppler shift. The bursty nature refers to the intermittent communication windows tied to the passage of meteors, while the high Doppler shift is caused by the relative motion between the meteor and the receiving station, resulting in frequency shifts in the received signal.

Meteor ionization burst communications have some limitations and challenges inasmuch as meteor showers or random meteors need to be present for ionization trails to be created. This limits the availability and predictability of communication windows. Additionally, communication opportunities are brief and unpredictable, typically lasting only a few seconds. This makes it challenging to establish extended or continuous communication. Further, the high Doppler shift experienced during meteor scatter propagation requires specialized techniques to account for frequency variations and maintain reliable communication.

Because of the thin air at an altitude of about 100 Km, the ion density is relatively low, even for plasmas heated by hypersonic bolides, yielding relatively low plasma frequencies. Generally, the optimal frequencies for meteor based burst communications are in the range of 30 MHz-150 MHz. Communications which exploit meteor produced ionization are thus at relatively low baud rates, and are intermittent, requiring several attempts with randomly arriving meteors to transfer a useful amount of data.

### SUMMARY OF THE INVENTION

Although other aspects of over-the-horizon communications are known, there is still a need for improving these over-the-horizon communications. One aspect of the present disclosure utilizes plasma streams or trails generated by hypersonic objects moving through the atmosphere to perform OTH communications. The hypersonic objects generate plasma streams that are longer in duration than meteor ionization and are operable with higher frequency electromagnetic waves. Further, the use of or exploitation of hypersonic objects allows a user to have more precise control the generation of the plasma stream rather than the randomness that occurs from meteors.

The rapidly advancing technology of hypersonic vehicles (HSVs) offer an opportunity for more reliable OTH communications at higher bandwidths. These opportunities may have at least three aspects: 1) exploiting HSVs for communications, 2) deliberately operating HSVs so as to optimize burst communications at tactically useful electromagnetic (EM) frequencies, such as in Link 16's 0.96-1.215 GHz band (or generally at about 1 GHZ), and 3) exploiting ground based radio or other EM networks to inexpensively and covertly detect and track HSVs. Compared to meteors, HSVs are slower, but operate at lower altitude with more persistent trails because vehicles do not burn up in the atmosphere. The denser air at lower altitudes yields a higher density of electrons at any given temperature. The higher density of electrons in turn yields a higher plasma frequency. For example, at an altitude of 6 Km (about 20,000 ft. or about 3.75 miles), the plasma frequency at Mach 6 is at about 1 GHz that is similar to the Link 16 band which would permit the necessary communication frequency.

In one aspect, an exemplary embodiment of the present disclosure may provide a system comprising: a manmade hypersonic object that generates a plasma stream in the atmosphere in response to the manmade hypersonic object moving at a hypersonic speed; a first OTH radar system at a first location; a second OTH radar system at a second location that is over the horizon relative to the first OTH radar at the first location; wherein the first OTH radar system is configured to transmit a signal to the plasma stream that is then reflected to the second OTH radar. In the present context, the term “OTH radar” applies to a distributed multi-static system of transmitter and receiver nodes. Tracking need not be accomplished by each individual node, but rather by aggregating data from multiple nodes in the network. This exemplary embodiment or another exemplary embodiment may further provide that the plasma stream is in the ionosphere. This exemplary embodiment or another exemplary embodiment may further provide that the hypersonic speed at which the manmade hypersonic object moves is greater than Mach 5. This exemplary embodiment or another exemplary embodiment may further provide that the signal is a burst communication. This exemplary embodiment or another exemplary embodiment may further provide that the signal is at a frequency in a range from 0.96-1.215 GHZ, corresponding to the plasma frequencies of HSVs moving at relevant altitudes. As HSV technologies and concepts of operations change, the operating frequencies of the present system will be adjusted from the 0.96-1.25 GHz range to optimize performance. This exemplary embodiment or another exemplary embodiment may further provide a plurality of forward radar systems, wherein the first OTH radar is one of the plurality of forward radar system, and the plurality of forward radar systems are on the same side of the horizon relative to each other, wherein the plurality of forward radar systems are localized with each other. This exemplary embodiment or another exemplary embodiment may further provide a tracking technique implemented by the plurality of forward radar systems are self-localized with each other to track the manmade hypersonic object based on the plurality of forward radar systems being self-localized with each other.

In another aspect, an exemplary embodiment of the present disclosure may provide a method comprising: providing a first OTH radar system; effecting the first OTH radar system to generate a signal; effecting the first OTH radar system to transmit the signal to a plasma stream in the atmosphere generated by a manmade hypersonic object; effecting the signal generated by the first OTH radar system to reflect from the plasma stream to a second OTH radar system that is located over the horizon from the first OTH; and effecting the first OTH radar system to communicate with the second OTH via the signal reflecting from the plasma stream generated by the manmade hypersonic object.

In yet another aspect, an exemplary embodiment of the present disclosure may provide a method comprising: providing a manmade object configured to move through the atmosphere at a hypersonic speed; effecting the manmade object to move at the hypersonic speed; effecting the manmade object to generate a plasma trail in response to the manmade object moving at the hypersonic speed; and effecting the plasma stream to reflect a signal from a first OTH radar system toward a second OTH radar system, wherein the first OTH radar system is at a first location and the second OTH radar system is at a second location over-the-horizon relative to the first location of the first OTH radar system.

In yet another aspect, an exemplary embodiment of the present disclosure may provide a method comprising: determine the presence of a plasma stream in the atmosphere that is generated by a manmade hypersonic object; transmitting a signal from a first OTH radar system to the plasma stream, wherein the first OTH radar system is at a first location; reflecting the signal from the plasma stream to a second OTH radar system, wherein the second OTH radar system is at a second location over-the-horizon relative to the first location of the first OTH radar system; and receiving the signal at the second OTH radar system.

In yet another aspect, an exemplary embodiment of the present disclosure may provide a method comprising: providing a first OTH radar system and a second OTH radar system; effecting the determination of the presence of a plasma stream that is generated by a manmade hypersonic object in the atmosphere; effecting a signal to be transmitted from a first OTH radar system to the plasma stream, wherein the first OTH radar system is at a first location; effecting the signal to be reflected from the plasma stream to a second OTH radar system, wherein the second OTH radar system is at a second location over-the-horizon from the first location of the first OTH radar system; and effecting the second signal to be received at the second OTH radar system.

In yet another aspect, an exemplary embodiment of the present disclosure may provide a system comprising: a first OTH communication system at a first location; a second OTH communication system at a second location that is over the horizon relative to the first OTH communication system at the first location; and wherein the first OTH communication system is configured to transmit a signal to a plasma stream generated by a manmade hypersonic object moving through atmosphere, and a reflected signal that is reflected from the plasma stream is received at the second OTH communication system. This exemplary embodiment or another exemplary embodiment may provide that properties of the manmade hypersonic object are processed at the second OTH communication system in response to receipt of the reflected signal. This exemplary embodiment or another exemplary embodiment may provide that the properties comprise course, speed, and altitude of the manmade hypersonic object. This exemplary embodiment or another exemplary embodiment may provide that wherein the first and second OTH communication systems comprises transmitter and receiver nodes, each of which define a distributed multi-static system at each respective first and second OTH communication system. This exemplary embodiment or another exemplary embodiment may provide that the distributed multi-static system is mobile. This exemplary embodiment or another exemplary embodiment may provide that nodes of the distributed multi-static system includes nodes to enable self-localization of the nodes.

This exemplary embodiment or another exemplary embodiment may further include a tracking technique performed by at least one of the first and second OTH communication systems, wherein the tracking technique tracks movement of the manmade hypersonic option. This exemplary embodiment or another exemplary embodiment may provide that a tracking accuracy is improved by using multiple long baselines between the nodes. This exemplary embodiment or another exemplary embodiment may provide that processor that executes the tracking technique uses apriori information of the atmosphere.

This exemplary embodiment or another exemplary embodiment may provide that the signal transmitted from the first OTH communication system is a burst communication signal. This exemplary embodiment or another exemplary embodiment may provide that the burst communication signal comprises information packets to enable self-localization.

In yet another aspect, an exemplary embodiment of the present disclosure may provide a method for tracking a hypersonic object, comprising: providing a plurality of over-the-horizon (OTH) transmitter nodes and receiver nodes as part of a distributed network; transmitting a signal from one of the transmitter nodes to a plasma stream in the atmosphere, wherein the plasms stream is generated by a manmade hypersonic object; receiving at one of the receiver nodes a reflected signal from the plasma stream to; and determining properties of the manmade hypersonic object. This exemplary embodiment or another exemplary embodiment may further include localizing a first OTH communication system with a plurality of other OTH communications systems located on the same side of the horizon as the first OTH communication system. This exemplary embodiment or another exemplary embodiment may further include synchronizing a first OTH communication system with a second OTH communication system to transmit the signal during a period when the plasma stream is present; and compensating for Doppler shift of the signal resulting from velocity of the manmade hypersonic object.

This exemplary embodiment or another exemplary embodiment may further include ng a first OTH communication system with a plurality of other OTH communications systems, wherein the first OTH communication is in a GPS-denied area. This exemplary embodiment or another exemplary embodiment may further include synchronizing the first OTH communication system with a second OTH communication system to transmit the signal during a period when the plasma stream is present, wherein the first OTH communication system and the second OTH communication system are each a pair of systems.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a diagrammatic view of the OTH communication system according to one aspect of the present disclosure.

FIG. 2A (FIG. 2A) is an operational diagrammatic view of a system of the present disclosure depicting a hypersonic vehicle at a first location generating a plasma trail in the atmosphere to establish communication between two over-the-horizon radar systems.

FIG. 2B (FIG. 2B) is an operational diagrammatic view of the system of the present disclosure depicting the hypersonic vehicle at a second location generating the plasma trail in the atmosphere to establish communication between two other over-the-horizon radar systems.

FIG. 2C (FIG. 2C) is an operational diagrammatic view of the system of the present disclosure depicting the hypersonic vehicle at a third location generating the plasma trail in the atmosphere to establish communication between two other over-the-horizon radar systems.

FIG. 3 (FIG. 3) is a flowchart depicting an exemplary method of the present disclosure.

FIG. 4 (FIG. 4) is another flowchart depicting an exemplary method of the present disclosure.

Similar numbers refer to similar parts throughout the drawings. Features of the drawings are not drawn to scale.

### DETAILED DESCRIPTION

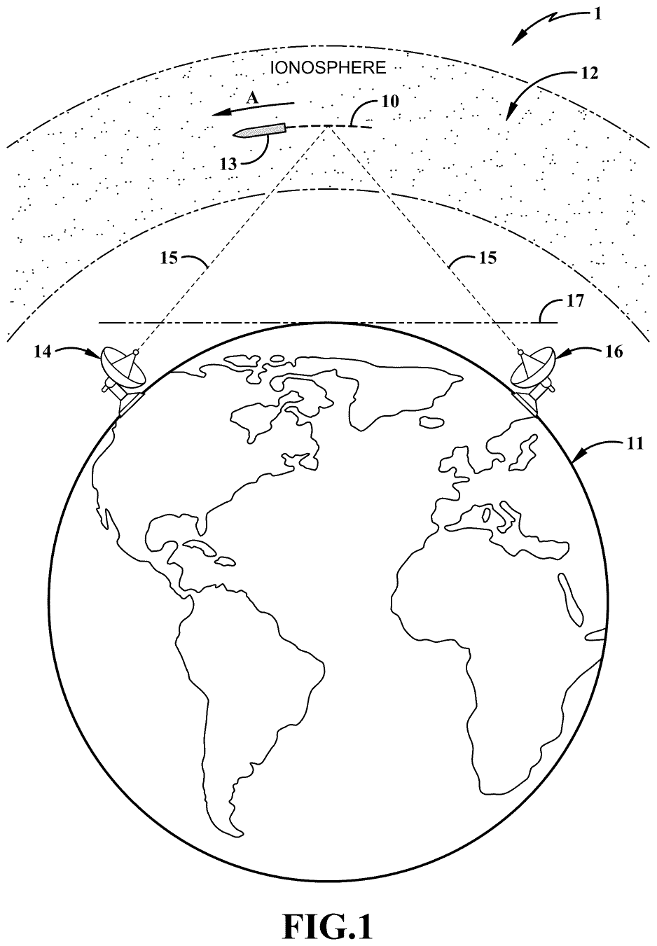

FIG. 1 depicts an over-the-horizon (OTH) communication system 1 according to one aspect of the present disclosure. A plasma stream 10 or trail of ionization is formed in the atmosphere at an altitude above the surface of the earth 11, such as in the stratosphere, mesosphere, or ionosphere 12, by moving a manmade object 13 at a hypersonic speed, as indicated by arrow A. An OTH communication system 14 (which may also be referred to as a first radar system 14) transmits and receives signals 15 that are reflected off stream 10 to communicate with a second communication system 16 (which may also be referred to as a second radar system 16) that is “over-the-horizon” inasmuch as there is no direct LOS between first radar system 14 and second radar system 16 due to the horizon 17.

The ionosphere 12 is a region within the Earth's atmosphere that spans parts of the mesosphere, thermosphere, and exosphere. It's not a distinct layer like the troposphere, stratosphere, mesosphere, and thermosphere, but rather a region characterized by the presence of ionized particles (charged particles) due to the absorption of high-energy solar radiation. The ionosphere 12 does not ordinarily have a specific altitude range, as its boundaries are not sharply defined. Instead, it varies in altitude based on factors like solar activity and time of day. Generally, the ionosphere starts in the upper mesosphere and extends into the lower thermosphere and exosphere. Some embodiments of the present disclosure provide for the object 13 to operate at altitudes less than 100,000 feet. Some embodiments of the present disclosure provide for the object 13 to operate at altitudes less than 50,000 feet. Still further, some embodiments of the present disclosure provide for the object 13 to operate at altitudes less than 20,000 feet. In one particular embodiment, system 1 utilizes or exploits object 13 moving in the atmosphere at an altitude ranging from about 15,000 feet to about 125,000 feet.

In accordance with the present disclosure, stream 10 is formed by hypersonic movement of object 13 (which may be a hypersonic vehicle (HSV)). The degree of ionization in the ionosphere or other layer of the atmosphere depends on the electron temperature of the average energy of the free electrons; i.e. plasma, at a particular altitude. When a hypersonic object 13 moves through the ionosphere 12 or other layer of the atmosphere, it creates the plasma stream 10 or trail behind it due to the intense heat generated by the object's high speed. Hypersonic refers to the speed at which the object's 13 movement through the ionosphere 12 or other layer of the atmosphere varies the chemistry of the atmosphere, typically a speed of about Mach 5 or greater. The ionosphere 12 is a region of Earth's upper atmosphere that is ionized by solar radiation, and it includes a layer of charged particles or ions. Further, while system 1 references the object 13 moving through the ionosphere 12, other layers/regions of the atmosphere or space may be utilized as well.

There are several types of manmade objects 13 or HSVs that can move at hypersonic speeds through the ionosphere 12 or other layer of the atmosphere, any of which can be utilized within system 1 of the present disclosure. These objects or HSVs are typically designed for specific purposes and take advantage of advanced technologies to achieve such high velocities. Some examples include hypersonic aircraft, regardless of whether it is manned or unmanned, powered or unpowered (such as glide vehicles), that are designed to travel at speeds greater than Mach 5 (approximately 6,174 km/h or 3,836 mph), which puts them in the hypersonic range. Some specific objects, such as hypersonic gliders operate at speeds between Mach 5 and Mach 20. Other hypersonic aircraft may use a combination of scramjet (supersonic combustion ramjet) engines and advanced aerodynamic designs to achieve hypersonic speeds. They can be used for reconnaissance, research, or potentially as future high-speed commercial transportation. Hypersonic missiles are unmanned vehicles that can travel at hypersonic speeds to deliver payloads to targets. They employ advanced propulsion systems, such as scramjets or rocket engines, to achieve the necessary velocities. Hypersonic missiles offer significant advantages in terms of speed and maneuverability, making them more difficult to intercept and allowing for rapid response times. Spacecraft reentry vehicles may be used to return spacecraft, such as crewed capsules or scientific payloads, from space back to Earth. During reentry, these vehicles experience hypersonic speeds due to the extreme velocities required to overcome Earth's gravitational pull. To withstand the intense heat generated during reentry, they are equipped with heat shields or thermal protection systems. Hypersonic experimental vehicles are experimental hypersonic vehicles used for scientific research, technology validation, and exploration. These vehicles are often launched on suborbital trajectories, reaching hypersonic speeds before descending back to Earth. They help researchers study the aerodynamics, materials, and propulsion systems required for sustained hypersonic flight. Hypersonic drones, also known as high-speed unmanned aerial systems (UASs), are being explored for various applications. These drones are designed to fly at hypersonic speeds, offering advantages such as rapid response, long-range capabilities, and enhanced maneuverability. They could be utilized in military operations, surveillance, or scientific research. As used herein, the term object 13 refers to an object that is manmade and not a meteor.

The shape and material of the hypersonic object 13 influence its interaction with the surrounding air molecules. The aerodynamic design of the object 13 affects the compression of air and the shockwave pattern formed during flight. The material properties, such as thermal conductivity and melting point, determine how the object can withstand the extreme heat. Different shapes and materials can result in varying degrees of ionization and plasma stream 10 or trail longevity.

When the hypersonic object 13 moves through the ionosphere 12 or other layer of the atmosphere, it generates a plasma stream 10 or trail primarily through two processes: aerodynamic heating and ionization. Regarding aerodynamic heating, as the hypersonic object 13 moves at extremely high speeds through the ionosphere 12 or other layer of the atmosphere, it encounters a significant increase in air pressure in front of it. This compression generates intense heat in the surrounding air, causing it to reach high temperatures. The elevated temperatures can lead to the ionization of the air molecules. This compression of the air also generates strong shockwaves and creates a region of intense heating known as the shock layer or bow shock. The shock layer is characterized by high temperatures and pressures. As the shock wave propagates, it creates an area of increased pressure, density, and temperature. The high temperatures in the shock wave region can cause ionization of the air molecules, resulting in the formation of an ionization stream. The intense aerodynamic heating in the shock layer causes the air molecules to gain energy. The increased energy leads to collisions between the molecules, breaking chemical bonds and separating electrons from their parent atoms. This process is known as dissociation and ionization. The high temperatures in the shock layer cause the air molecules to dissociate into atoms and further ionize into positively charged ions and free electrons which ultimately form the plasma stream 10.

Regarding ionization, the dissociation and ionization processes result in the formation of the plasma stream 10 or trail behind the hypersonic object 13. Plasma is often referred to as the fourth state of matter, comprising charged particles (positive ions and free electrons) that are electrically conductive. The intense heat in the shock layer sustains the ionization process, continually replenishing the plasma stream 10 or trail as the hypersonic object 13 moves through the ionosphere 12 or other layer of the atmosphere. The energy from the object's 13 high-speed motion is converted into thermal energy, further enhancing the ionization and maintaining the plasma state of the stream 10 or trail.

The plasma stream's 10 characteristics can vary based on factors such as the hypersonic object's 13 speed, altitude, shape, and material properties. These factors influence the intensity and duration of the ionization process, which, in turn, affects the formation and persistence of the plasma stream 10 or trail. Once the vehicle moves past, the ionization stream dissipates relatively quickly as the ionized particles recombine with neutral molecules and the air returns to its normal state. The duration of the plasma trail's persistence can range from fractions of a second to a few minutes, depending on the specific conditions and characteristics of the hypersonic flight.

The duration of ionization or the plasma stream 10 or trail behind the hypersonic object 13 depends on a variety of factors. The speed of the object 13 affects the duration of the ionization. A higher velocity leads to more intense heating and a longer-lasting plasma trail. Similarly, the altitude at which the object 13 flies above earth 11 also plays a role. Higher altitudes generally have thinner air, which can result in less drag and reduced heat transfer to the surrounding air. Consequently, the duration of ionization may be shorter at higher altitudes.

The density, composition, and temperature of the ionosphere 12 or other layer of the atmosphere can affect the duration of ionization. The ionosphere 12 or other layer of the atmosphere is not uniform and varies with location, time, and solar activity. Solar flares and geomagnetic storms, for example, can significantly impact the atmosphere's properties. Higher atmospheric density can lead to increased drag and more efficient heat transfer, which may affect the plasma trail's persistence.

The energy dissipation rate of the plasma stream 10 or trail is relevant in determining its longevity. Factors such as molecular collisions, recombination processes, and energy transfer mechanisms within the plasma trail influence how quickly the ions and electrons lose their energy and recombine to form neutral particles. The specific chemical reactions and energy transfer processes in the plasma trail will determine how long it remains ionized.

The ionization of the ionosphere 12 or other layer of the atmosphere will affect electromagnetic waves, such as signal 15, passing through it. The presence of the plasma stream 10 or trail will alter the propagation characteristics of radio waves or signal 15.

Effectuating OTH communications utilizing localized ionized particles in stream 10 in ionosphere 12 or other layer of the atmosphere may be accomplished by some exemplary hardware and software configurations. To effectuate transmission of signal 15, each of the first radar system 14 and the second radar system 16 may include a specialized transmitter capable of generating signals within the desired frequency range, typically around 1 GHZ, such as Link 16. Each radar 14, 16 defines a node in each respective OTH communication system. The transmitter should have sufficient power output to overcome attenuation and propagate signals 15 over long distances (i.e., to the stream 10). Each radar system 14, 16 should include an antenna system designed for OTH communication, taking into account the specific frequency range and desired radiation pattern. Antennas with high-gain and directional characteristics may be used to optimize signal transmission and reception. Each radar system 14, 16 should include a dedicated receiver capable of tuning into the desired frequency range and demodulating received signals 15. The receiver should have the sensitivity to detect weak signals and the capability to handle the specific modulation schemes used in the communication system. There should also be an antenna system designed to receive signals 15, complementing the transmitter's antenna. The antenna should be optimized for the frequency range and should have suitable gain and directivity to capture and focus incoming signals.

Each radar system 14, 16 may perform signal processing and modulation. The choice of modulation scheme depends on the specific requirements of the communication system 1. Some exemplary modulation schemes include Amplitude Modulation (AM), Single Sideband (SSB), and Frequency Shift Keying (FSK). The selected modulation scheme should be suitable for long-range communication and efficient use of the available bandwidth.

Each radar system 14, 16 may also include signal processing algorithms may be employed to improve the quality of received signals, mitigate interference and noise, and enhance the overall performance of the communication system. These algorithms can include adaptive equalization, noise reduction, and interference cancellation techniques.

Each radar system 14, 16 may also include ionosphere or other layer of the atmosphere propagation models and prediction tools. Accurate apriori knowledge of the ionospheric or atmospheric conditions is used for successful over-the-horizon communications. While the speed of sound depends primarily on temperature, the air density limits the maximum ion density achievable in a hypersonic shock. Air density varies with altitude, temperature, tidal forces, and many other factors. In addition to air density, the details of air composition determine the ionizability of the air. For example, ozone (O3) has a first ionization energy of 12.43 eV, molecular oxygen (O2) has a first ionization energy of 12.06 eV, and water vapor (H2O) has a first ionization energy of 12.62 eV, all lower than the 15.58 eV first ionization energy of nitrogen (N2) [NIST Chemistry Webbook, SRD69] or the 15.76 eV first ionization energy of Argon. Thus, the ion density of heated air will be dominated by O2, slightly modulated by the altitude-dependent concentrations of O3 and H2O. At the altitudes of interest for hypersonics, the concentration of water vapor is very low, and even in the ozonosphere, 15-35 Km above Earth's surface, the concentration of O3 is on the order of 10 ppm, so that ionization of O2 will usually dominate. Because the electromagnetic plasma frequency depends on ion density, the reflection and scattering properties of the hypersonic plasma depend on altitude. Sophisticated ionospheric or atmospheric models and algorithms, based on historical data and real-time measurements, can help estimate the behavior of radio waves in the ionosphere or other layer of the atmosphere and optimize the system configuration accordingly.

Further, propagation prediction tools are specialized software tools are available that use ionosphere or other layer of the atmosphere models and geospatial data to predict the behavior of signals 15 in different atmospheric conditions. These tools assist in selecting appropriate frequencies, antenna angles, and other parameters to optimize system performance. These prediction tools may be trained utilizing artificial intelligence through any supervised or unsupervised predictive algorithm. For example, a first-order estimate of ion density can be derived from the Saha equation (see Saha, Megh Nad (1920). “LIII.Ionization in the solar chromosphere”, Philosophical Magazine. Series 6. 40 (238): 472-488.) The Saha equation relates the ionization state of a gas in thermal equilibrium to its temperature and pressure. The Saha equation is:

$$\frac{{n}_{i + 1} {n}_{e}}{{n}_{i}} = \frac{2}{{λ}_{th}^{3}} \frac{{g}_{i + 1}}{{g}_{i}} exp [ - \frac{( {ε}_{i + 1} - {ε}_{i} )}{{k}_{B} T} ] \qquad ( Equation 1 )$$

where:
is the density of atoms in the ith state of ionization, that is with/electrons removed;
is the degeneracy of states for the H-ions;
is the energy required to remove/electrons from a neutral atom, creating an H-level ion;
is the electron density;
is the Boltzmann constant;
is the thermal de Broglie wavelength of an electron
is the mass of an electron
is the temperature of the gas; and
is the Planck constant.

Some parameters of the Saha equation (Equation 1, supra) include the density of free electrons ne, and the density of atomic and molecular species in various ionization states. Ionized species provide the electrons for the plasma, and because electrons are much lighter than ions, the motions of the electrons dominate the plasma frequency. By using radio transmissions at various frequencies and detecting them remotely (e.g., over the horizon), the plasma frequency associated with the shock can be determined, and from that the temperature and density of ionized electrons computed.

Each radar system 14, 16 may also include encryption and authentication techniques to ensure the security and confidentiality of sensitive information transmitted over signal 15. These measures protect the data from unauthorized access and ensure secure communications in military or other sensitive applications.

The radar systems 14, 16 may use burst communication signals 15 to communicate with each other via stream 10. When signal 15 encounters the ionized stream 10 or trail, it is reflected by the ionized particles within the stream 10 or trail. The interaction between the signal 15 wave and the plasma stream 10 trail leads to changes in the signal's path and propagation characteristics from one radar systems 14, 16 to the other. Ionization burst communications are characterized by short-duration communication windows or bursts that occur when a stream 10 is present in the atmosphere in response to hypersonic object 13 creating a temporary ionized stream 10 or trail.

To take advantage of ionization bursts, the communication and/or radar systems 14, 16 are synchronized to transmit signals during the periods when the stream 10 or trail present. Timing may be important as the communication window is limited to the duration of the ionization stream 10. The relative motion between the hypersonic object 13 generating stream 10, the transmitter on one radar system (either 14 or 16), and the receiver on the other radar system (the other of 14 or 16) causes a significant Doppler shift in the received signal 15. The Doppler shift results from the varying velocity of the object 13 and affects the frequency of the received signal 15. Specialized techniques are employed to compensate for the Doppler shift and maintain accurate communication.

During the burst window, both the transmitter and the receiver actively transmit and receive signals. The receiver's task is to detect the signals 15 reflected from the ionized stream 10 and process them to extract meaningful information. Signal processing techniques such as matched filtering, error correction coding, and adaptive equalization may be employed to enhance the signal quality.

In addition to OTH communications, system 1 can be used as an object tracking system. For example, the system 1 of the present disclosure may also utilize an object 13 operated by an enemy or hostile opposing party and exploit the plasma stream 10 generated by the hostile object 13. System 1 provides the ability to utilize the plasma stream 10 from the enemy object 13 to track the enemy's object 13. For example, in the scenario in which system 1 is utilized to track an enemy's object 13, if there are multiple radar stations/systems or other communication systems, 14, 16 that are over the horizon 17 relative to each other and are not normally expected to be able to communicate with each other, if they suddenly are able to communicate signal 15 between the respective radio stations, then system 1 can determine that the presence of stream 10 or trail created by the enemy object 13 is effectuating or enabling that communication. Then, the system 1 uses algorithms to track the movement of enemy object 13 based on the knowledge that the radar stations 14, 16 would not normally be able to communicate with each other but for the presence of the stream 10 created by the enemy object 13. When the enemy object 13 is able to be tracked through system 1, the system 1 provides more advanced guidance and detection of incoming enemy object 13.

For tracking, the goal is to estimate speed, altitude, and course of the HSV with a distributed set of transmitters and receivers operating at low power in ad hoc networks that can easily be moved or even be mobile, such as in an autonomous swarm. The distributed network infers the course and speed of the vehicle from the patterns of signal receptions for each transmit node. Given the vehicle speed and the electron densities, shock-wave models then provide the air density. From the air density, the altitude of the HSV is determined. Thus, the networked system of the present system determines the course, speed, and altitude of an HSV. By placing transmit and receive nodes over the horizon from each other, ground-clutter interference is minimized, and warning time of arrival of a red force threat is extended. In addition, the OTH detection also can also be exploited for “burst” communications of information packets which can contain additional information, such as metadata to enable swarm self-localization.

If the distributed network includes enough nodes (typically four or more), the timings of the OTH signals can be exploited to refine the location of each node. By self-localizing a swarm in this way, the network further improves the ability to track moving objects. It also enables self-localization of forces in GPS-denied areas. For a non-cooperative HSV, localization will include iteratively update the loci of both the swarm and the HSV.

Another feature of the present system is that tracking accuracy will improve with increasing distance between nodes (baselines). By exploiting multiple long baselines, the tracking accuracy can be made more precise than any one node can achieve. This will allow each node to operate with a combination of smaller aperture and lower power than a single isolated system would require.

Take for example a scenario where there is a plurality of OTH radar communication systems, such as the first radar system 14, the second radar system 16 and other similar systems that are communicating with each other with wide field of view. The radar systems that are over the horizon 17 with respect to each other should not be able to communicate. However, suddenly, if several pairs of radar systems that are over the horizon 17 and should not be able to communicate with each other suddenly are able to communicate with each other, then system 1 will understand and determine that there is a reflection happening in the ionosphere 12 or other layer of the atmosphere. If the reflection from the ionosphere 12 or other layer of the atmosphere is created by stream 10 from object 13, then the interactions between the radar systems located over the horizon 17 relative to each other can be coordinated to track the object 13.

If the two over the horizon radar systems lose their communication link in a very short time, such as a few seconds, then the system 1 may be able to determine that a stream 10 was generated by a meteor or other short-lived object. However, if these two radar systems, such as first radar system 14 and second radar system 16 that are over the horizon 17 relative to each other are able to remain linked or communicate for many seconds, such as ten seconds or more, then the system 1 may determine that the stream 10 may likely have been be generated by an object 13 that needs more investigation, discrimination, scrutiny or examination by a central processing unit (CPU) to report and track the movement of object 13 generating plasma trail or plasma stream 10.

While the illustrations and embodiments provide herein pertain to a RF signal 15 between first radar system 14 and second radar system 16, it is noted that the concepts discussed herein are universally applicable to various types of electromagnetic (EM) signals. These encompass a diverse array of signal 15 types, each playing a role in OTH communication and technology. For instance, other signals that may be utilized as signal 15 may include microwave signals, infrared signals, visible light signals, laser signals, X-rays and gamma rays signals, and the like. Thus, the principles elucidated in this context can be extended to an extensive range of electromagnetic signals 15, contributing to an even broader spectrum of applications. Further, in this regard, when using a signal 15 other than the RF signal exemplified herein, the respective first communication system 14 and second communication system 16 would not necessarily be radar systems. The first communication system 14 and second communication system 16 would include electrical transmitters and receivers in a system configured for the type of signal being utilized. For example, when microwaves are used as the signal 15, the first communication system 14 and second communication system 16 would include microwave transmitters and receivers. When lasers are used as the signal 15, the first communication system 14 and second communication system 16 would include laser generators/transmitters and receivers. Other corresponding first system 14 and second system 16 would include other necessary transmitters and receivers.

Additionally, while examples have been detailed herein with respect to the ionosphere 12, it is to be understood that system 1 is also applicable to other layers of the atmosphere to effectuate the OTH communications. For example, the HSV object 13 can operate/move to generate plasma stream 10 in the troposphere. The HSV object 13 may be launched from the ground and ascends through the troposphere, the lowest layer of the Earth's atmosphere. This layer extends from the Earth's surface to an average altitude of about 8-15 kilometers (5-9 miles). The HSV object 13 may use powerful engines and aerodynamic design to push through the dense air of the troposphere, overcoming both atmospheric resistance and gravity at a hypersonic speed to generate plasma stream 10.

In another example, the HSV object 13 can operate/move to generate plasma stream 10 in the stratosphere. Entering the stratosphere (from either above or below), the HSV object 13 encounters thinner air and begins to experience a different set of conditions. The stratosphere extends from the top of the troposphere to around 50 kilometers (31 miles) above the Earth's surface. In this layer, the objects 13 hypersonic speed and altitude allow it to take advantage of the lower atmospheric density to generate plasma stream 10. Object 13 continues to climb, using its propulsion system to maintain its velocity as the air thins further.

In another example, the HSV object 13 can operate/move to generate plasma stream 10 in the mesosphere. Rising through the mesosphere (or descending from space into the mesosphere), the HSV object 13 faces even lower air density and colder temperatures. The mesosphere extends from the top of the stratosphere to an altitude of around 85 kilometers (53 miles). At these altitudes, the vehicle's advanced heat shield technology may be important, as it encounters extreme heating due to its high velocity. The HSV continues to navigate through this layer to generate plasma stream 10, using controlled propulsion and thermal management systems to handle the harsh conditions.

In another example, the HSV object 13 can operate/move to generate plasma stream 10 in the thermosphere. In the thermosphere, the HSV object 13 enters a region characterized by very low atmospheric density and extremely high temperatures. Starting around 85 kilometers above the Earth's surface, the thermosphere extends into space. At these altitudes, the hypersonic vehicle's speed allows it to skim through the thin atmosphere with minimal drag and generate plasma stream 10. Object 13 may leverage advanced materials and cooling mechanisms to manage the intense heat generated by interactions with the sparse air molecules.

In another example, the HSV object 13 can operate/move to generate plasma stream 10 in the exosphere, the outermost layer of the Earth's atmosphere, the HSV object 13 encounters an environment that is almost vacuum-like. This layer gradually transitions into the vacuum of space and may need to move faster than it would in the lower layers of the atmosphere to generate the plasma stream 10.

Having thus described some exemplary features, configurations, and operating parameters of system 1, additional reference is made to another example usage or exploitation of system 1 to perform object tracking. The tracking performed by system 1 may be accomplished by developing or studying a pattern of pairs of radar systems that are over the horizon relative to each other.

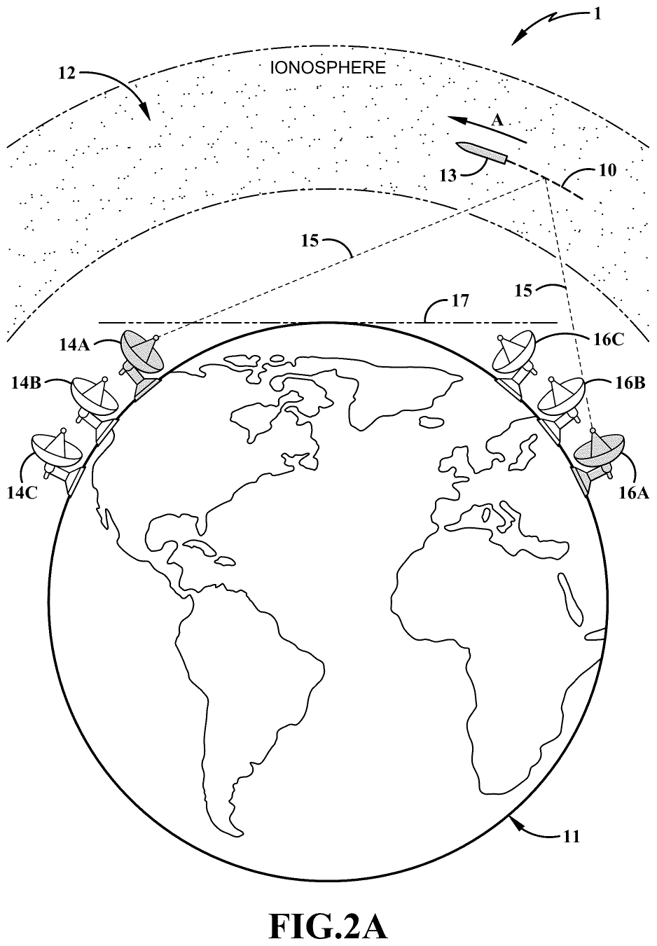

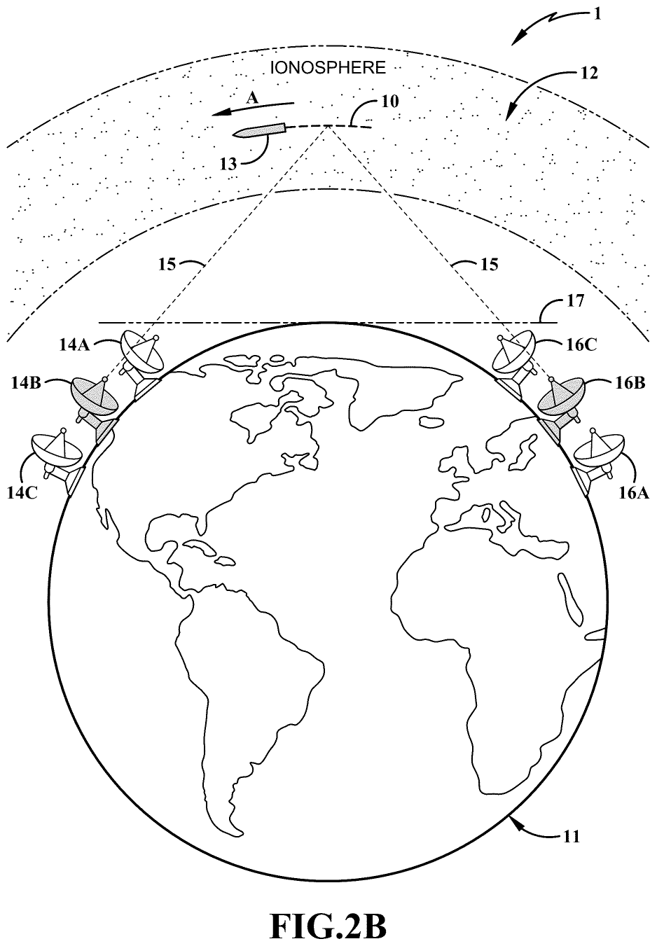

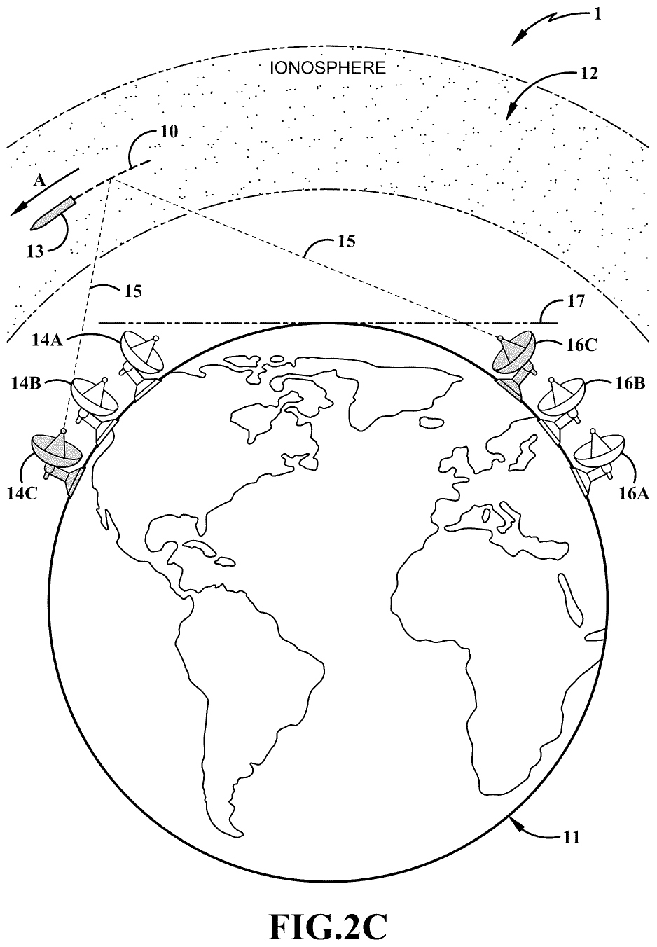

FIG. 2A-FIG. 2C depicts system 1 being utilized to track an object 13 moving at hypersonic speed based on its plasma stream 10 or trail. In this example, object 13 may be a hostile object or it could be a friendly object that is purposefully used to exploit object tracking.

In FIG. 2A, the object 13 is at a first position generating a plasma stream 10 or trail. A forward first radar system 14A is able to communicate its signal 15 with a rearward second radar 16A, where radar system 14A and 16A are over the horizon 17 relative to each other.

FIG. 2B depicts the object 13 having moved in the direction of Arrow A in which a forward third radar 14B (or other communication system) is in communication with a rearward fourth radar 16B (or other communication system). When the object has moved to the position shown in FIG. 2B, the forward first radar 14A is no longer in communication with the rearward second radar 16A. System 1 may begin to establish a pattern of the moving object 13 in order to track its position and movement through the atmosphere. Particularly, the forward radars 14A, 14B have line-of-sight communication with each other because they are on the same side of the horizon 17. Therefore, they are able to self-localize and determine that the forward first radar 14A was in communication with the rearward second radar 16A but subsequently lost that connection and another connection was established between forward third radar 14B and the rearward fourth radar 16B. One exemplary manner in which the forward communication systems, such as radars 14A, 14B, and 14C are able to localize or self-localize, which may be an ad hoc self-localization, is taught in U.S. Pat. No. 11,290,363, which is commonly owned at the time of filing the present disclosure and names the same inventor, as the present disclosure.

FIG. 2C depict the continuation of this pattern in which the forward fifth radar 14C is able to utilize plasma stream 10 of object 13 moving through the atmosphere when it establishes its connection with the rearward sixth radar 16C. Based on the continued pattern of the connection and disconnection between radar systems that are over the horizon 17 relative to each other, the system 1 is able to establish a pattern between the localized radars on the same side of the horizon 17 to triangulate or otherwise track the movement of object 13.

The tracking of the object 13 shown in the manner utilizing the patterned acquisition by radar systems that have line-of-sight communication with each other (such as radar or other communication systems 14A, 14B, and 14C) can be utilized to track both friendly and enemy objects 13 moving at hypersonic speeds through the atmosphere.

The radar stations on the same side of the horizon, such as the forward stations 14A, 14B and 14C can be self-localized. The localization information of these radio stations can be transmitted to every station in that local network such that every radio or radar station understands and knows the location of the others in the local network. Then, if one of the radar stations moves, it can update its location based on the network. Further, if one of the local radar stations communicates with a radar system or radar station that is over the horizon 17, such as any or the rear radar systems 16A, 16B or 16C, then that forward radar system may update the remainder of the localized networks on the forward side of the horizon, namely, radar systems 14A, 14B and 14C. Once one of the forward radar systems, either 14A, 14B or 14C establishes a connection via plasma stream 10 with one of the rear radar systems, either 16A, 16B or 16C, then the localized network on the forward side of the horizon 17 can be utilized to start tracking the hypersonic object 13 as it moves in the direction of Arrow A. The same process would also be operable in the reverse with the rear radar system 16A, 16B, and 16C being self-localized to identify the forward radar systems 14A, 14B, and 14C.

In one exemplary embodiment, the tracking of object 13 may be accomplished via a tracking technique, such as radio tomography. Radio tomography is a technique used to monitor and study various atmospheric parameters, such as the presence of stream 10 from object 13, by analyzing the behavior of radio waves or signal(s) 15 as those signals pass through the atmosphere. Radio tomography is based on the principle that the refractive index of the atmosphere or ionosphere 12 or other layer of the atmosphere is affected by factors such as temperature, humidity, pressure, and other meteorological variables, such as the presence of stream 10. Communication system 1 may use radio tomography to exploit the use of an array of radio transmitters and receivers, such as those in forward radars 14A, 14B, and 14C, rear radars 16A, 16B, and 16C, or both, strategically placed around a region of interest. These transmitters emit radio waves or other signals 15, which travel through the atmosphere and are received by multiple receivers, which may be on the same side of horizon 17 or may be over-the-horizon. By analyzing the changes in the received signals, system 1 can determine how the atmosphere's properties are distributed and changing (i.e., the movement of the stream 10) over the monitored area. The change and movement of stream 10 in the atmosphere will allow for the tracking of object 13. One non-limiting and exemplary manner in which the radio tomography may be accomplished is through an inversion technique which applies mathematical algorithms to reconstruct the spatial distribution of atmospheric parameters, such as the presence of stream 10, amongst other atmospheric parameters. This allows inversion process or technique to create a “tomographic image” of the atmosphere, which should show the stream 10 and show other variations in the studied parameters across the monitored area. The variations could then be tracked over time to thereby track object 13. Further, the tomographic image or successive tomographic image could be analyzed through artificial intelligence or other machine-learned technique to classify or discriminate the object 13.

For example, the results of the tomographic image or successive tomographic images can be analyzed or discriminated via artificial intelligence or other machine-learned technique to determine whether object 13 is a manmade object, such as an enemy missile, or a natural phenomenon, such as a meteor. If the system 1 determines that the object 13 is a hostile or enemy object, that classification or determination may be provided to another countermeasure or warning system. Then, the countermeasure or warning system should take appropriate measures in an attempt to disable or warn the existence of hostile object 13.

The system 1 of the present disclosure may additionally include one or more sensor to sense or gather data pertaining to the surrounding environment or operation of the system 1. Some exemplary sensors capable of being electronically coupled with the system 1 of the present disclosure (either directly connected to the system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; Photo/Light sensors sensing ambient light intensity, ambient, Day/night, UV exposure; TV/IR sensors sensing light wavelength; Temperature sensors sensing machine or motor temperature, ambient air temperature, and environmental temperature; and Moisture Sensors sensing surrounding moisture levels. The additional sensors can be used to sense data relevant to establishing requirements of stream 10 to operate in ionosphere 12 or other layer of the atmosphere.

The device, assembly, or system of the present disclosure may include wireless communication logic coupled to sensors on the device, assembly, or system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the device, assembly, or system of the present disclosure may serve as a repeater, or the devices, assemblies, or systems of the present disclosure may be connected together in a mesh network to relay signals from one device, assembly, or system to the next. However, the individual device, assembly, or system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the device, assembly, or system of the present disclosure may differ from embodiment to embodiment. In one embodiment, alerts and signals from the device, assembly, or system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department. Thus, if a particular device, assembly, or system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

The system also allows individuals to access the device, assembly, or system of the present disclosure for configuration and diagnostic purposes. In that case, the individual processors or microcontrollers of the device, assembly, or system of the present disclosure may be configured to act as Web servers that use a protocol like hypertext transfer protocol (HTTP) to provide an online interface that can be used to configure the device, assembly, or system. In some embodiments, the systems may be used to configure several devices, assemblies, or systems of the present disclosure at once. For example, if several devices, assemblies, or systems are of the same model and are in similar locations in the same location, it may not be necessary to configure the devices, assemblies, or systems individually. Instead, an individual may provide configuration information, including baseline operational parameters, for several devices, assemblies, or systems at once.

As described herein, aspects of the present disclosure may include one or more electrical or other similar secondary components and/or systems therein. The present disclosure is therefore contemplated and will be understood to include any necessary operational components thereof. For example, electrical components will be understood to include any suitable and necessary wiring, fuses, or the like for normal operation thereof. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

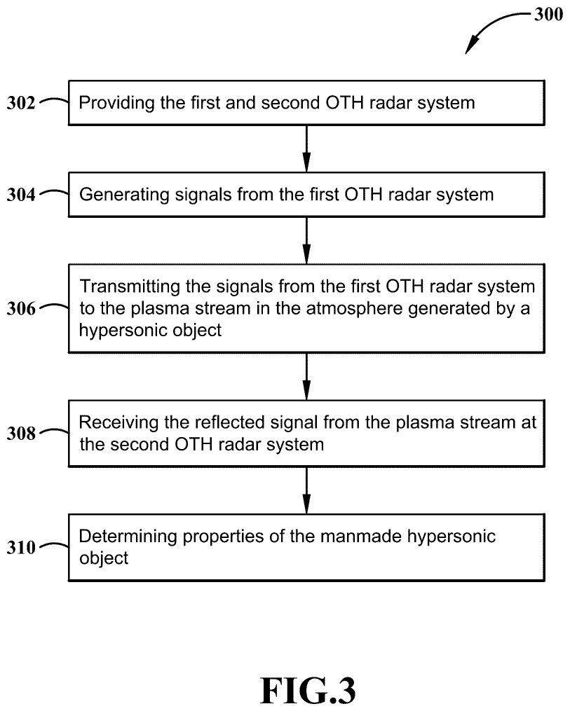

For example, FIG. 3 depicts an exemplary method 300 of system 1. Method 300 may include providing the first OTH radar system 14, which is shown generally at 302. Step 302 may also include providing the second OTH radar system 16. Method 300 may include generating signal 15 with the first OTH radar system 14, which is shown generally at 304. Method 300 may include transmitting the signal 15 from the first OTH radar system 14 to plasma stream 10 in the atmosphere, wherein the plasma stream is generated by the manmade hypersonic object 13, which is shown generally at 306. Method 300 may include reflecting the signal 15 from the plasma stream 10 to the second OTH radar system 16 that is located over the horizon 17 from the first OTH radar system 14, which is shown generally at 308. Method 300 may include communicating between the first OTH radar system 14 and the second OTH radar system 16 via the signal 15 reflecting from the plasma stream 10 generated by the manmade hypersonic object 13, thereby determining the properties of the manmade hypersonic object 13, which is shown generally at 310. It should be understood that the system operations include powering up the system components, transmitting and receiving from distributed networks that are over the horizon (OTH) from each other. The CONOPS (concept of operations) may include requirements for security and mobility, as well as power conservation.

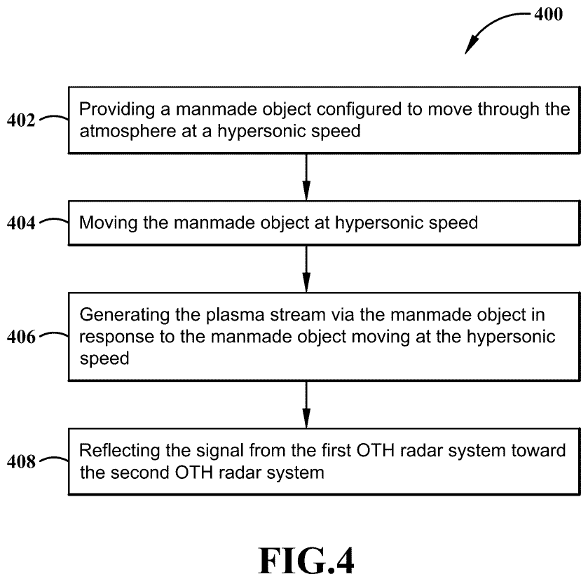

In another example, FIG. 4 depicts an exemplary method 400 of system 1 in which the manmade object works in cooperation with the system. Method 400 may include providing manmade object 13 configured to move through the atmosphere at a hypersonic speed, which is shown generally at 402. Method 400 may include moving the manmade object 13 at hypersonic speed, which is shown generally at 404. Method 400 may include generating plasma stream 10 via the manmade object 13 in response to the manmade object 13 moving at the hypersonic speed, which is shown generally at 406. Method 400 may include reflecting the signal 15 from the plasma stream 10, wherein the signal was generated at the first OTH radar system 14, toward the second OTH radar system 16, which is shown generally at 408, wherein the first OTH radar system is at a first location and the second OTH radar system is at a second location over-the-horizon relative to the first location of the first OTH radar system. The cooperative hypersonic vehicle in a way that optimizes its mission priorities. For example, if OTH comms of ground units is the main priority, the HSV will fly at the altitude, course, and speed that maximizes the effectiveness of communication via reflection and scattering from the hypersonic plasma.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A system comprising:
a first over-the-horizon (OTH) communication system at a first location;
a second OTH communication system at a second location that is over the horizon relative to the first OTH communication system at the first location; and
wherein the first OTH communication system is configured to transmit a signal to a plasma stream generated by a manmade hypersonic object moving through atmosphere, and a reflected signal that is reflected from the plasma stream is received at the second OTH communication system.

2. The system of claim 1, wherein properties of the manmade hypersonic object are processed at the second OTH communication system in response to receipt of the reflected signal.

3. The system of claim 1, wherein the properties comprise course, speed, and altitude of the manmade hypersonic object.

4. The system of claim 1, wherein the first and second OTH communication systems comprises transmitter and receiver nodes, each of which define a distributed multi-static system at each respective first and second OTH communication system.

5. The system of claim 4, wherein the distributed multi-static system is mobile.

6. The system of claim 4, wherein the nodes of the distributed multi-static system includes nodes to enable self-localization of the nodes.

7. The system of claim 4, further comprising:
a tracking technique performed by at least one of the first and second OTH communication systems, wherein the tracking technique tracks movement of the manmade hypersonic option.

8. The system of claim 7, wherein a tracking accuracy is improved by using multiple long baselines between the nodes.

9. The system of claim 7, wherein a processor that executes the tracking technique uses apriori information of the atmosphere.

10. The system of claim 1, wherein the plasma stream is in the ionosphere.

11. The system of claim 1, wherein the signal transmitted from the first OTH communication system is a burst communication signal.

12. The system of claim 11, wherein the burst communication signal comprises information packets to enable self-localization.

13. The system of claim 1, further comprising a plurality of forward communication systems, wherein the first OTH communication system is one of the plurality of forward communication system, and the plurality of forward communication systems are on the same side of the horizon relative to each other, wherein the plurality of forward communication systems are self-localized with each other.

14. The system of claim 13, further comprising:
a tracking technique implemented by the plurality of forward communication systems that are self-localized with each other to track the manmade hypersonic object.

15. The system of claim 1, further comprising:
an altitude at which the object moves through atmosphere, wherein the altitude is in a range from about 25,000 feet to about 125,000 feet.

16. A method for tracking a hypersonic object, comprising:
providing a plurality of over-the-horizon (OTH) transmitter nodes and receiver nodes as part of a distributed network;
transmitting a signal from one of the transmitter nodes to a plasma stream in the atmosphere, wherein the plasms stream is generated by a manmade hypersonic object;
receiving at one of the receiver nodes a reflected signal from the plasma stream to; and
determining properties of the manmade hypersonic object.

17. The method of claim 16, further comprising:
localizing a first OTH communication system with a plurality of other OTH communications systems located on the same side of the horizon as the first OTH communication system.

18. The method of claim 16, further comprising:
synchronizing a first OTH communication system with a second OTH communication system to transmit the signal during a period when the plasma stream is present; and
compensating for Doppler shift of the signal resulting from velocity of the manmade hypersonic object.

19. The method of claim 16, further comprising:
localizing a first OTH communication system with a plurality of other OTH communications systems, wherein the first OTH communication is in a GPS-denied area.

20. The method of claim 19, further comprising:
synchronizing the first OTH communication system with a second OTH communication system to transmit the signal during a period when the plasma stream is present, wherein the first OTH communication system and the second OTH communication system are each a pair of systems.
